(19) United States
(12) Patent Application Publication
(10) Pub. No.: US 2024/0081205 A1
(43) Pub. Date: Mar. 14, 2024

(54) Modular Attachment to Construction Scaffold Systems

(71) Applicants: Susannah C. Drake, Denver, CO (US); Minghao Du, Brooklyn, NY (US); Sarah Bojsen, New York, NY (US)

(72) Inventors: Susannah C. Drake, Denver, CO (US); Minghao Du, Brooklyn, NY (US); Sarah Bojsen, New York, NY (US)

(21) Appl. No.: 18/367,793

(22) Filed: Sep. 13, 2023

Related U.S. Application Data
(60) Provisional application No. 63/406,457, filed on Sep. 14, 2022.

(51) Int. Cl. A01G 27/00; E04G 5/00

(52) U.S. Cl. CPC A01G 27/005; E04G 5/00

(57) ABSTRACT

A water collector and drain for a scaffolding, having: the scaffolding having at least one horizontal beam and at least one vertical beam; a fabric basin coupled to the at least one horizontal beam, the fabric basin having an open end and a concaved end; a drain exit fluidly connected to the fabric basin at the concaved end; and a connection arrangement for attaching the fabric basis to the at least one horizontal beam such that the open end at least partially extends past the horizontal beam of the scaffolding.

### CROSS-REFERENCE TO RELATED APPLICATION

This application claims priority to U.S. Provisional Application No. 63/406,457 filed Sep. 14, 2022 and hereby incorporates by reference in its entirety the contents of the application.

### BACKGROUND OF THE INVENTION

### Field of the Invention

The present disclosure relates to a drainage device for rainwater. More specifically, the drainage device is for scaffolding drainage that directs water runoff from the scaffolding to tree planters.

### Description of Related Art

Construction scaffolding is erected for new building construction and for renovation of existing structures. It often stays in place for many months if not years. Scaffolding is often erected near or over trees. This deprives trees of water and often leads to the trees' death. Therefore, there is a current need in the art for improvements to scaffolding that captures and directs rain water that collects on scaffold systems, channels the water into a downspout, and irrigates existing street trees.

Similarly, commercial scaffolding structures are known from the publications: CN204090647U (Chen Lixin, 2015, Multi-span Greenhouse); CN210777716U (Hubei Hengy Dingsheng Env Art Engineering Co. LTD, 2020, Waterproof Sign Board—Gutter mounted on one side close to sign board to drain the shed); and CN215858950U (Yantai Qingquan Building Mat Co LTD, 2022, Scaffold with a mat of pipes for drainage).

### SUMMARY OF THE INVENTION

A water collector and drain for a scaffolding, having: the scaffolding having at least one horizontal beam and at least one vertical beam; a fabric basin coupled to the at least one horizontal beam, the fabric basin having an open end and a concaved end; a drain exit fluidly connected to the fabric basin at the concaved end; and a connection arrangement for attaching the fabric basis to the at least one horizontal beam such that the open end at least partially extends past the horizontal beam of the scaffolding.

An example of the water collector and drain for a scaffolding, further may include a filter fluidly connected between the concaved end of the fabric basin and the drain exit.

An example of the water collector and drain for a scaffolding, further may include a replaceable filter.

An example of the water collector and drain for a scaffolding, further may include a drain hose fluidly connected to the drain exit.

An example of the water collector and drain for a scaffolding, further may include the drain hose is coupled to the vertical beam of the scaffolding.

An example of the water collector and drain for a scaffolding, further may include the fabric basin further includes: a beam clamp for adjustably fixing to the at least one horizontal beam; at least one cable adjustably coupled to the beam clamp and adjustably coupled to the fabric basin at two ends; and at least one beam coupled to the fabric basin with the at least one cable.

An example of the water collector and drain for a scaffolding, further may include the at least one cable and at least one beam adjustably coupled to rigidly support the fabric basin such that the open end is greater in square area than the concaved end.

An example of the water collector and drain for a scaffolding, further may include a storage tank fluidly connected to the fabric basin.

An example of the water collector and drain for a scaffolding, further may include a fabric basin having a collection end and a funnel end; a drain pipe fluidly connected to the fabric basin at the funnel end; and a connection arrangement for attaching the fabric basin to a scaffolding framework such that the collection end at least partially extends past at least one horizontal beam of the scaffolding.

An example of the water collector and drain for a scaffolding, further may include a filter fluidly connected between the funnel end of the fabric basin and the drain pipe.

An example of the water collector and drain for a scaffolding, further may include a replaceable filter.

An example of the water collector and drain for a scaffolding, further may include a drain hose fluidly connected to the funnel end.

An example of the water collector and drain for a scaffolding, further may include the drain hose coupled to a beam of the scaffolding.

An example of the water collector and drain for a scaffolding, further may include the fabric basin further includes: a beam clamp for adjustably fixing to the at least one horizontal beam; at least one cable adjustably coupled to the beam clamp and adjustably coupled to the fabric basin at two ends; and at least one beam coupled to the fabric basin with the at least one cable.

An example of the water collector and drain for a scaffolding, further may include the at least one cable and at least one beam are adjustably coupled to rigidly support the fabric basin such that the collection end is greater in square area than the funnel end.

An example of the water collector and drain for a scaffolding, further may include a storage tank fluidly connected to the fabric basin.

An example of the water collector and drain for a scaffolding, further may include: the scaffold having at least one horizontal beam and at least one vertical beam; a fabric basin coupled to the at least one horizontal beam, the fabric basin having an open end and a concaved end; a drain exit fluidly connected to the fabric basin at the concaved end; and a connection arrangement for attaching the fabric basis to the at least one horizontal beam such that the open end at least partially extends past the horizontal beam of the scaffold.

An example of the water collector and drain for a scaffolding, further may include: a beam clamp for adjustably fixing to the at least one horizontal beam; at least one cable adjustably coupled to the beam clamp and adjustably coupled to the fabric basin at two ends; and at least one beam coupled to the fabric basin with the at least one cable.

An example of the water collector and drain for a scaffolding, further may include the at least one cable and at least one beam are adjustably coupled to rigidly support the fabric basin such that the open end is greater in square area than the concaved end.

An example of the water collector and drain for a scaffolding, further may include the fabric basin further comprises a rigid structure at the edges of the fabric basin configured to maintain the open ends shape.

### BRIEF DESCRIPTION OF THE DRAWINGS

Other features, advantages and details of the present invention will emerge on reading the following description of several embodiments of the invention given by way of illustration and not being limiting, said description being made with reference to the appended drawings.

FIG. 1 displays a tree map and active sidewalk shed map demonstrating the relationship between street trees and sidewalk sheds for a typical area in New York City;

FIG. 2 displays and example of a typical construction scaffold system with component breakdown in section;

FIG. 3 displays scaffold components in sections and elevation;

FIG. 4 displays a scaffold with details and the relationship to water;

FIG. 5 displays a relationship between street trees, scaffolding, and water flow in NYC;

FIG. 6 displays a side view of exemplary fabric basin shapes;

FIG. 7 displays section drawing of the preferred embodiment;

FIG. 8 displays a side view of the attachment to existing scaffolding and construction of the fabric basin;

FIG. 9A displays a beam clamp in use;

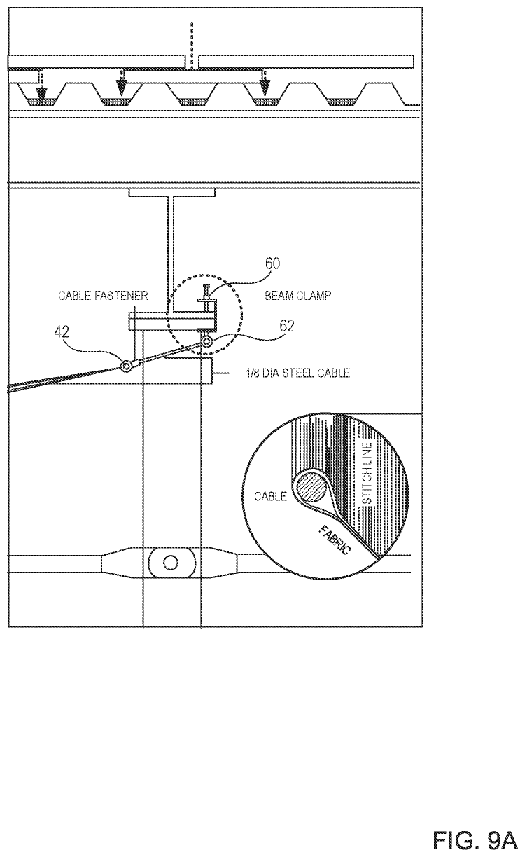

FIG. 9B displays a beam clamp;

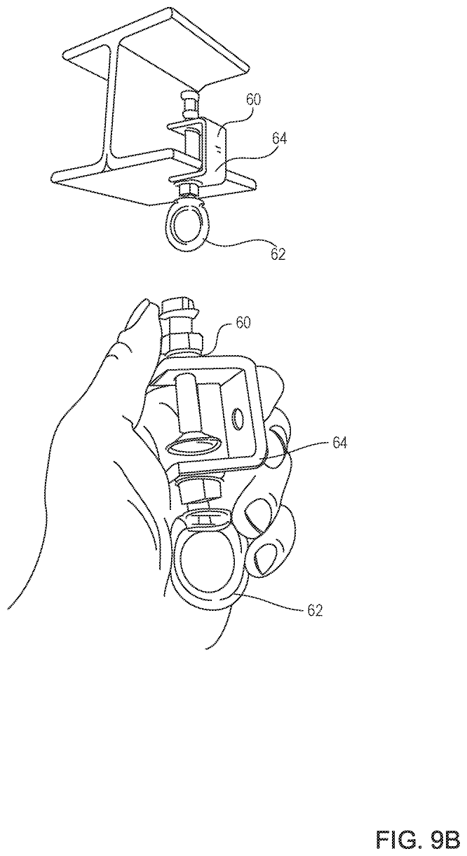

FIG. 10A displays a cable fastener in use;

FIG. 10B displays a cable fastener;

FIG. 11A displays an end hook attachment to steel pipe in use;

FIG. 11B displays an end hook attachment;

FIG. 12A displays a hose connector and leak diverter tarp in use;

FIG. 12B displays a hose connector and leak diverter tarp; and

FIG. 13 displays a flexible PVC hose, PVC pipe, and connector bracket.

### DESCRIPTION OF THE INVENTION

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

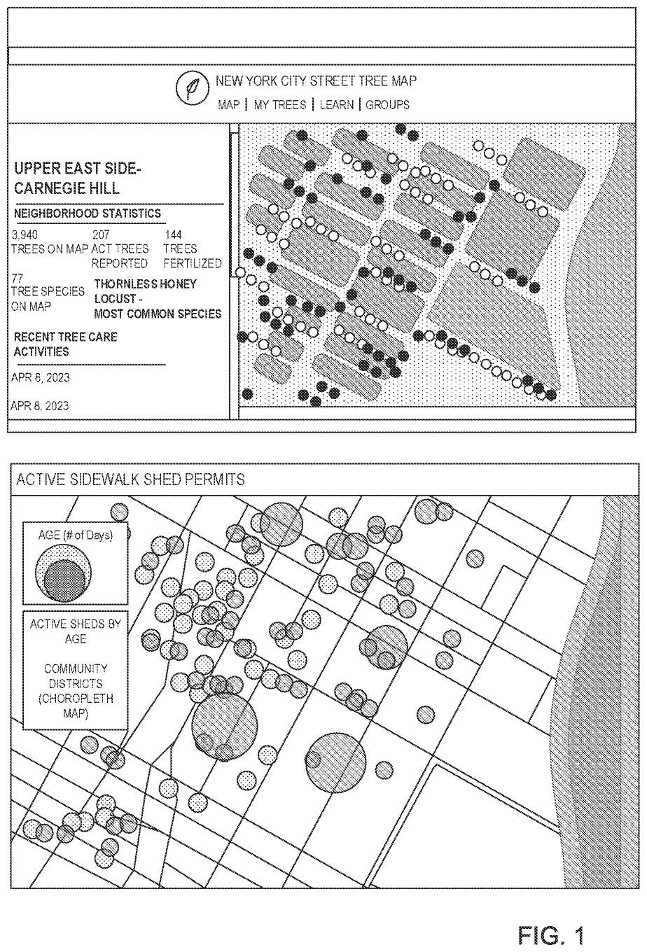

FIG. 1 consists of computer screen shots of exemplary images from New York City Park Maps which displays a map of trees and active sidewalk shed maps demonstrating the relationship between street trees and sidewalk sheds for a typical area in New York City. This example is disclosed to illustrate the prevalence of vegetation in an urban area.

The invention disclosed herein is a retrofit apparatus that can be attached to existing construction scaffolding 10 to direct rain water to tree planters. This invention captures and directs rain water that collects on scaffolding systems 10, channels the water into a downspout and irrigates existing street trees. The goal of the invention is to reduce urban street tree mortality during construction.

The disclosure relates to an assembly of parts including cable, fabric, hose, pipe, connectors, and PVC tubing that is used to direct water off of construction scaffolding 10 into tree pits and planters. The attachment collects water in a flexible fabric basin 20 suspended from scaffolding 10 and directs it through a flexible drainage pipe 30 and PVC tube to trees.

The system includes a number of components that are combined in a specific manner to fit between bays of scaffold structures 10. Water drains by sheet flow into a fabric membrane or basin 20 suspended by steel cables 40 sewn around the perimeter. Steel or rigid pipes may line each side. At the ends of the pipe is a cap 42 with a loop through which additional cable can be threaded and fastened to the clamp 60 above. The clamp 60 has a ring loop 62 at its base 64 through which the cable 40 is threaded and then connected back.

At the base 22 of the fabric basin 20, a filter 70 and connected set are connected to the base 22. These elements facilitate drainage into a flexible PVC pipe 32 and then into a hard PVC pipe. This tube 80 is connected to the vertical structure 14 of the scaffold 10 with a pipe standoff connector. At the base 22, another segment of flexible hose directs water into the tree pit. This section is secured with steel u-shaped irrigation stakes.

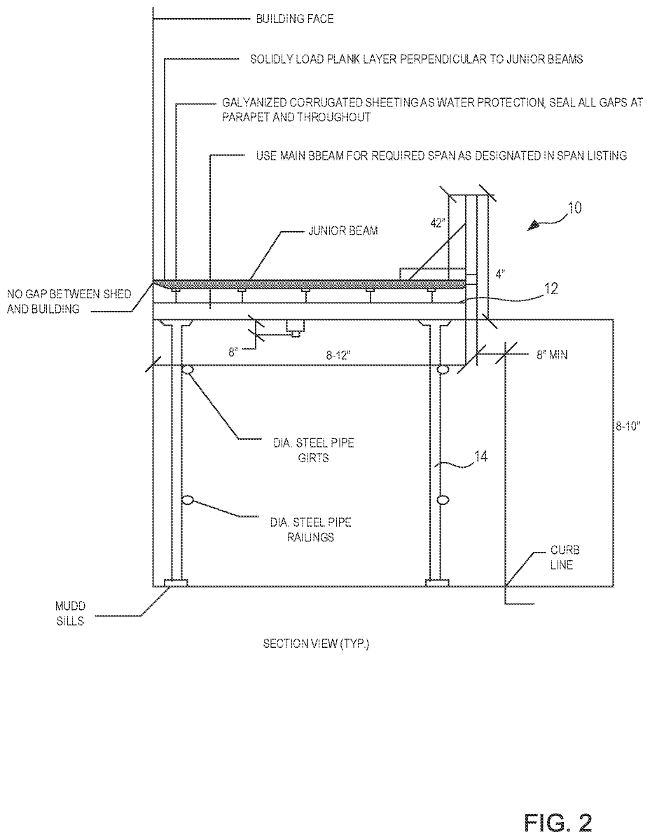

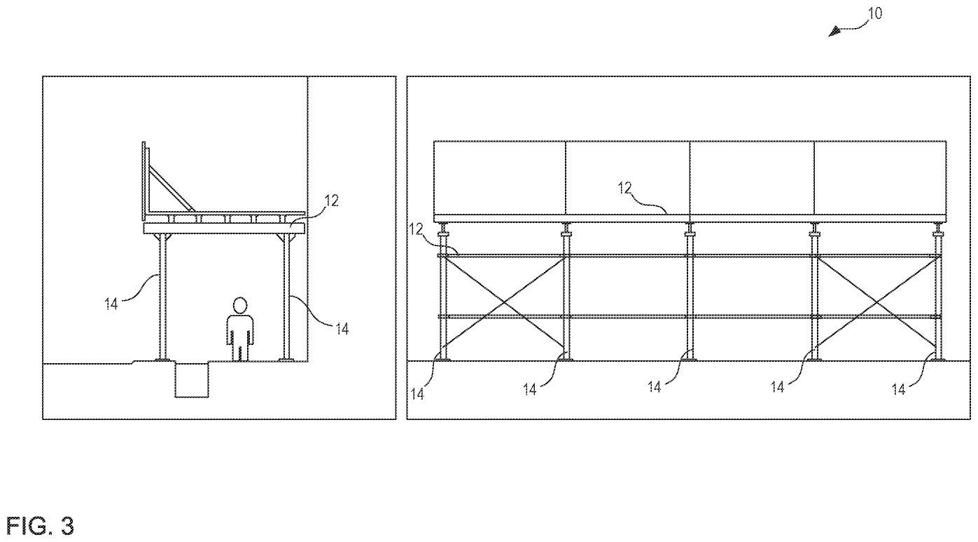

As shown in FIGS. 2 and 3, the scaffolding 10 may be like any scaffolding used in commercial or residential construction sites. The scaffolding 10 may be made of wood, plastic, metal, or any material commonly used for scaffolding structures. The scaffolding 10 may have horizontal beams 12 and vertical beams 14 which are structured to aid in construction sites. The scaffolding 10 may be located or constructed against a building or a standalone structure. The horizontal beams 12 may be used for walking on or additional walking spans may be placed over the horizontal beams 12. The vertical beams 14 maintain the structure of the scaffolding 10 in an upright position. Diagonal beams may be included to aid in the structural integrity of the scaffolding 10.

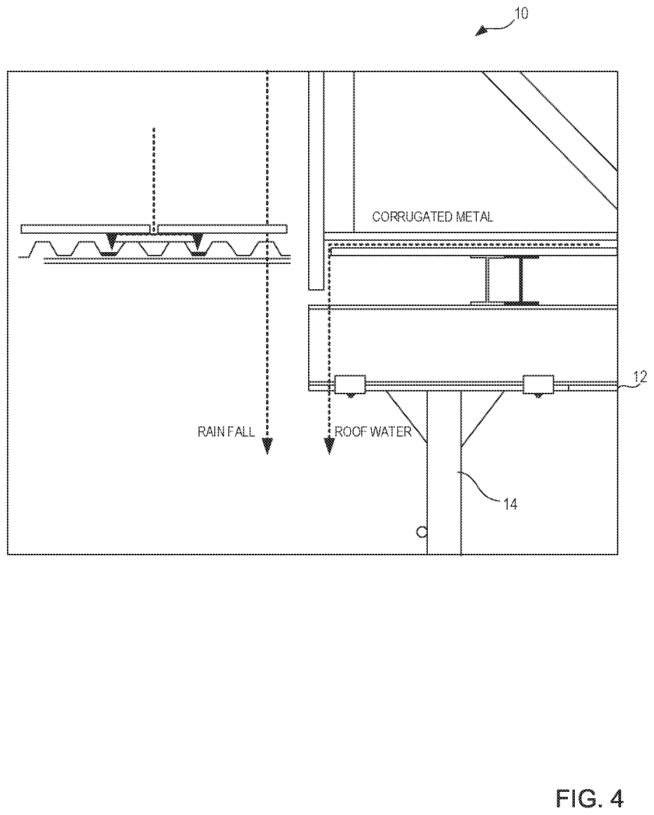

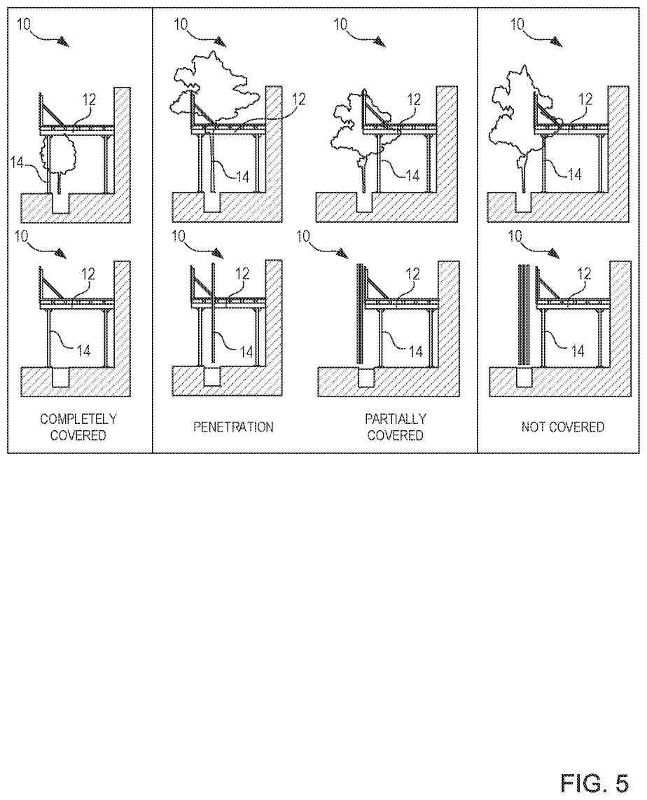

FIGS. 4 and 5 illustrate the relationship between the scaffolding structure 10, vegetation, and rain fall. Rain, water, and other debris may fall from above downward onto the scaffolding structure 10 and either fall past the scaffolding structure 10 or contact the scaffolding 10 and run off downward after pooling. In corrugated metal scaffolding 10, water pools in the valleys which forms stagnant water. Vegetation may grow next to, under, between, or around the scaffolding structure 10. Rain water that is not inhibited by the scaffolding structure 10 contacts the vegetation which waters the vegetation. Rain water that is inhibited by the scaffolding structure 10 runs off and collects in the fabric basin 20 to advantageously water the vegetation.

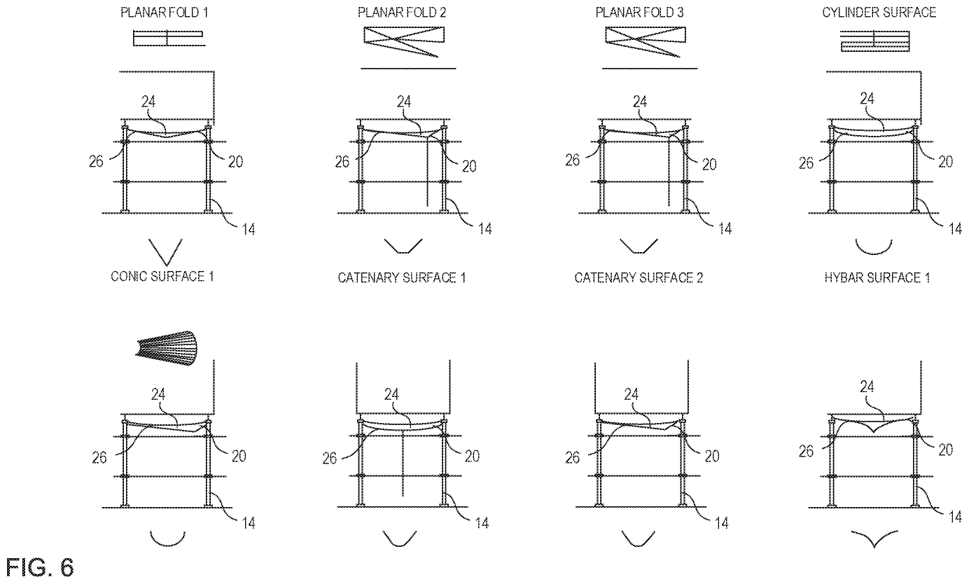

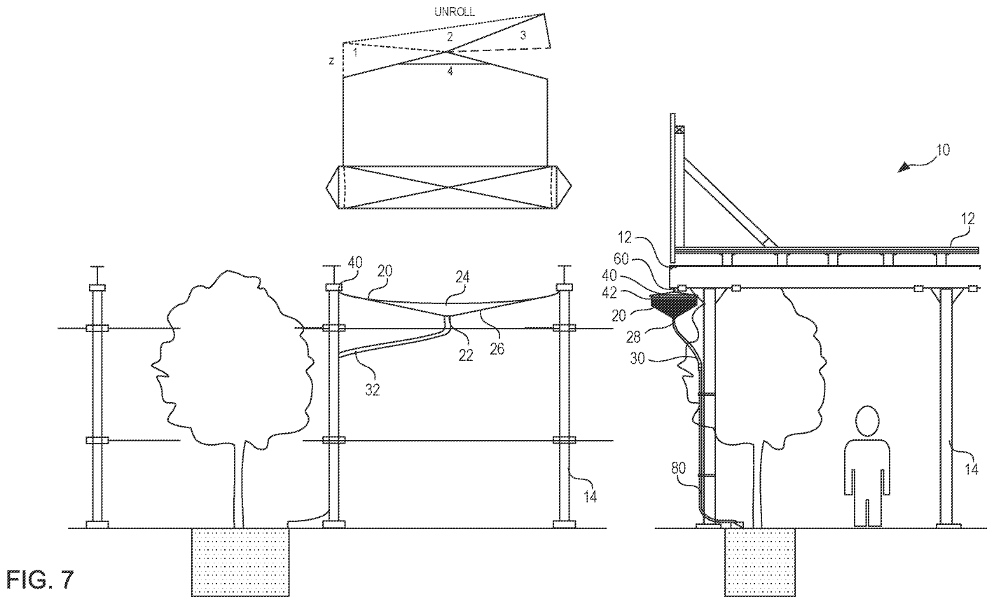

As shown in FIGS. 6 and 7, the fabric membrane or basin 20 may be a mesh fabric-like material. The fabric basin 20 is configured to collect rain water, run off water, or any other liquid that may run off of the scaffolding structure 10. The fabric basin 20 may be stretched out or configured to be in any shape, but is preferably in a rectangular shape. The fabric basin 20 may have an open end 24 or collection end 24 for water collection and a concaved end 26 or a funnel end 26. The concaved end 26 may be smaller in area and diameter than the open end 24. Liquid or water will collect in the concave end 26 and flow to the concaved end 26. Preferably, the fabric basin 20 is a rectangular segment of durable waterproof fabric folded along drainage planes to create a funnel or basin. The size of the fabric basin 20 may be adapted for regional rainfall data and spacing of structural supports. The shape and structure of the fabric basin 20 may be any concave-like shape which may funnel water and debris that enters from the open end 24. Examples of the fabric basin 20 shape are shown in FIG. 6. Stainless steel cable 40 may be sewn into the fabric basin 20 perimeter for structure and to maintain a desired shape.

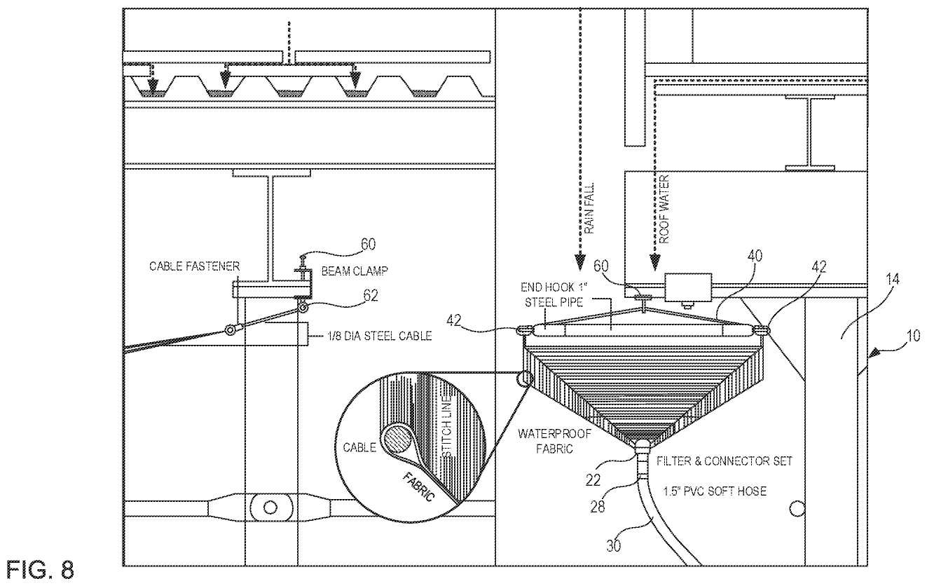

As shown in FIG. 8, cable 40 and clips or hangers 60 are used to connect the fabric basin 20 to the scaffolding 10. Preferably, the fabric basin 20 is connected to the scaffolding 10 at a horizontal beam 12 where at least a portion of the open end 24 of the fabric basin 20 extends past the vertical beam 14 of the scaffolding structure 10. This advantageously allows rain water and run off water to be collected simultaneously. To maintain such a ridged structure of the fabric basin 20, cable hangers 42 may attach the fabric basin 20 to a flexible frame. Cable fasteners 42 may secure the cable 40 and cable components to each other to maintain the structure of the fabric basin 20. A stabilizer pipe 44, made out of any material but preferably made of stainless steel, may be coupled at either side or through the fabric basin 20 to maintain a ridged structure. Cable fasteners 42 may be coupled at corners of the fabric basin 20 or at specific attachment points to better hang or fit the fabric basin 20 at least partially under the scaffolding structure 10.

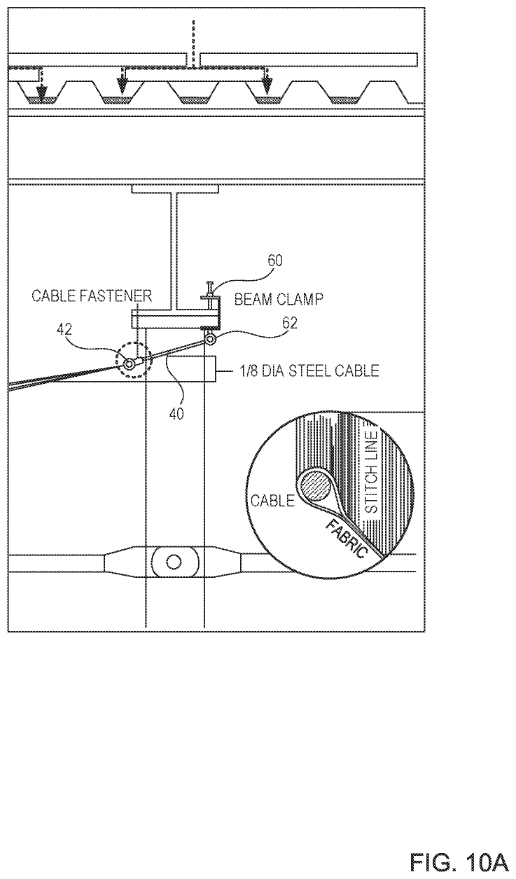

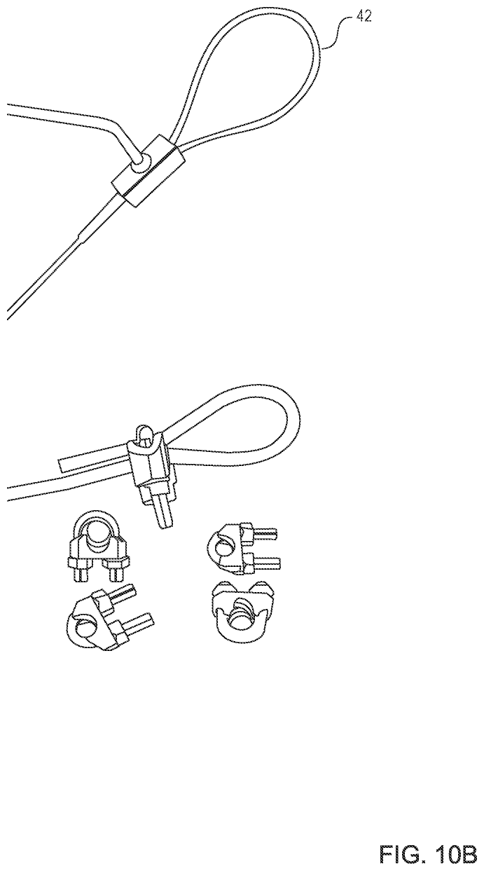

As shown in FIGS. 10A and 10B, a beam clamp 60 may be used to secure or adjustably fix the cable 40 to a beam of the scaffolding structure 10. Preferably, the beam clamp 60 adjustably fixes the cable 40 to a horizontal beam 12 of the scaffolding structure 10. The end of the cable 40 may be rounded or tied to the beam clamp 60 such that the cable 40 may rotate or be adjustable. The beam clamp 60 may have an eye or ring loop 62 which the cable 40 is adjustably fixed to.

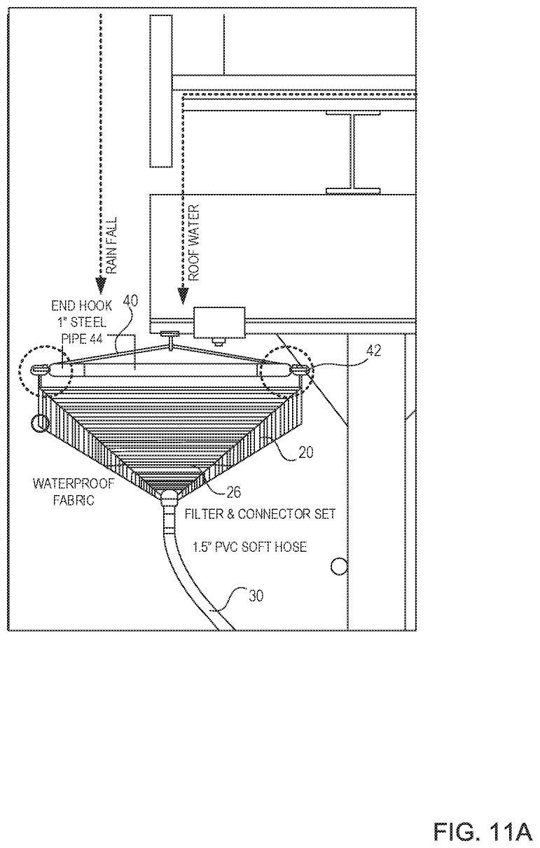

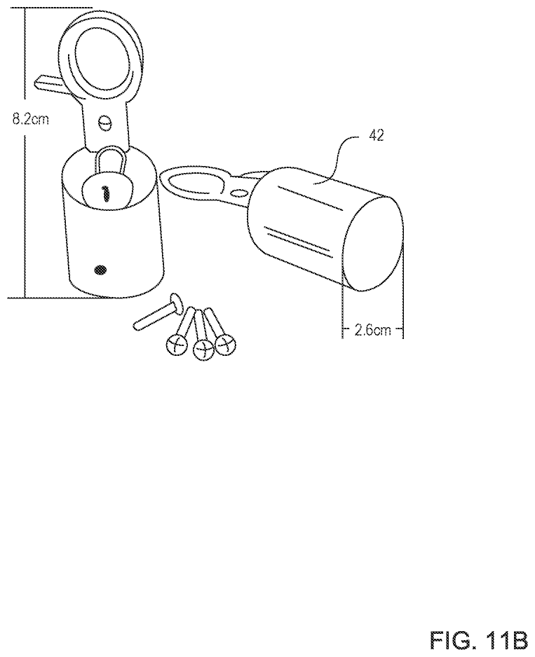

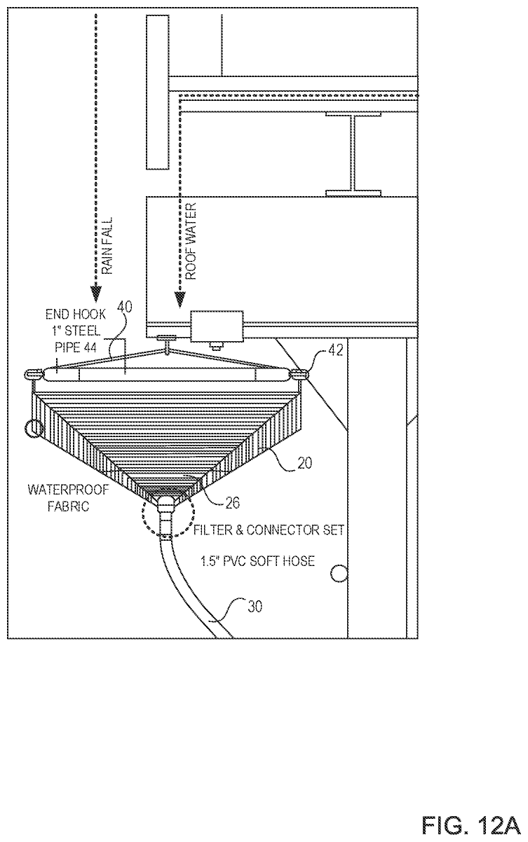

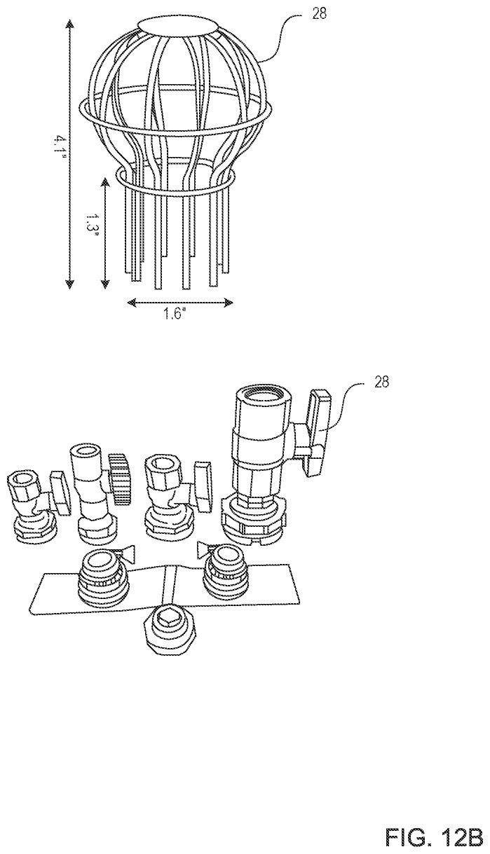

FIGS. 11-12 illustrate an embodiment of the cable fasteners 42 and connection arrangement for attaching the fabric basis 20 to the horizontal beam 12 such that the open end 24 at least partially extends past the horizontal beam 12 of the scaffolding 10. The connection arrangement may include a beam or stabilizer pipe 44 adjustably coupled to rigidly support the fabric basin 20 such that the open end 24 is greater in square area than the concaved end 26. The length of the cable 40 may be adjusted to accommodate onsite variability of the scaffolding structure 10 and external elements.

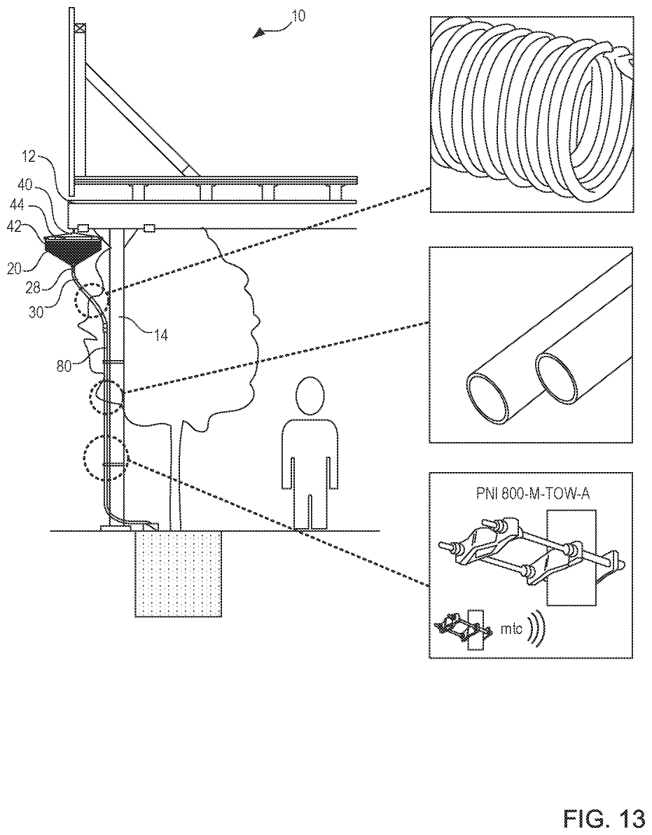

FIGS. 13-14 illustrate an embodiment of the invention having a drain 28 and tube 30. As shown, the fabric basin 20 is adjustably fixed to the scaffolding structure 10 adjacent to a tree. A drain 28 and tube 30 are connected to the scaffolding structure 10 such that fluid flows off of the scaffolding structure 10, to the fabric basin 20, through the drain 28, and down the tube 30 to the bottom of the tree to water the tree. The drain 28 may be releasably and fluidly fixed to the drain end 26 such that water will flow from the fabric basin 20 to the drain 28 and a leak diverter tarp may aid in providing proper fluid flow. The drain 28 may have a tube 80 attached such that the fluid continues to flow from the fabric basin 20 to the end of the tube 80 at the base of a tree or vegetation. The tube 80 may be tied or connected to the scaffolding structure 10, preferably a vertical beam 14. In one embodiment, a filter 70 fluidly connected between the concaved end 24 of the fabric basin 20 and the drain 28 may be installed to prevent debris or unwanted materials from entering the tube 80. A PN 800-M-TOW-A may be installed to stabilize a connection of a gutter downspouts to the scaffold structural supports.

The invention claimed is:

1. A water collector and drain for a scaffolding, comprising:
the scaffolding having at least one horizontal beam and at least one vertical beam;
a fabric basin coupled to the at least one horizontal beam, the fabric basin having an open end and a concaved end;
a drain exit fluidly connected to the fabric basin at the concaved end; and
a connection arrangement for attaching the fabric basin to the at least one horizontal beam such that the open end at least partially extends past the horizontal beam of the scaffolding.

2. The water collector and drain for a scaffolding of claim 1, further comprising: a filter fluidly connected between the concaved end of the fabric basin and the drain exit.

3. The water collector and drain for a scaffolding of claim 2, wherein the filter is replaceable.

4. The water collector and drain for a scaffolding of claim 1, further comprising a drain hose fluidly connected to the drain exit.

5. The water collector and drain for a scaffolding of claim 4, wherein the drain hose is coupled to the vertical beam of the scaffolding.

6. The water collector and drain for a scaffolding of claim 1, wherein the fabric basin further comprises:
a beam clamp for adjustably fixing to the at least one horizontal beam;
at least one cable adjustably coupled to the beam clamp and adjustably coupled to the fabric basin at two ends; and at least one beam coupled to the fabric basin with the at least one cable.

7. The water collector and drain for a scaffolding of claim 6, wherein the at least one cable and at least one beam are adjustably coupled to rigidly support the fabric basin such that the open end is greater in square area than the concaved end.

8. The water collector and drain for a scaffolding of claim 1, further comprising a storage tank fluidly connected to the fabric basin.

9. A rain water trap and drain, comprising:
a fabric basin having a collection end and a funnel end;
a drain pipe fluidly connected to the fabric basin at the funnel end; and
a connection arrangement for attaching the fabric basin to a scaffolding framework such that the collection end at least partially extends past at least one horizontal beam of the scaffolding.

10. The rain water trap and drain of claim 9, further comprising: a filter fluidly connected between the funnel end of the fabric basin and the drain pipe.

11. The rain water trap and drain of claim 10, wherein the filter is replaceable.

12. The rain water trap and drain of claim 9, further comprising a drain hose fluidly connected to the funnel end.

13. The rain water trap and drain of claim 12, wherein the drain hose is coupled to a beam of the scaffolding.

14. The rain water trap and drain of claim 9, wherein the fabric basin further comprises:
a beam clamp for adjustably fixing to the at least one horizontal beam;
at least one cable adjustably coupled to the beam clamp and adjustably coupled to the fabric basin at two ends; and at least one beam coupled to the fabric basin with the at least one cable.

15. The rain water trap and drain of claim 14, wherein the at least one cable and at least one beam are adjustably coupled to rigidly support the fabric basin such that the collection end is greater in square area than the funnel end.

16. The rain water trap and drain of claim 1, further comprising a storage tank fluidly connected to the fabric basin.

17. A water collection and drainage attachment for a scaffold, comprising:
the scaffold having at least one horizontal beam and at least one vertical beam;
a fabric basin coupled to the at least one horizontal beam, the fabric basin having an open end and a concaved end;
a drain exit fluidly connected to the fabric basin at the concaved end; and
a connection arrangement for attaching the fabric basin to the at least one horizontal beam such that the open end at least partially extends past the horizontal beam of the scaffold.

18. The water collection and drainage attachment for a scaffold of claim 17, wherein the fabric basin further comprises:
a beam clamp for adjustably fixing to the at least one horizontal beam;
at least one cable adjustably coupled to the beam clamp and adjustably coupled to the fabric basin at two ends; and at least one beam coupled to the fabric basin with the at least one cable.

19. The water collection and drainage attachment for a scaffold of claim 18, wherein the at least one cable and at least one beam are adjustably coupled to rigidly support the fabric basin such that the open end is greater in square area than the concaved end.

20. The water collection and drainage attachment for a scaffold of claim 19, wherein the fabric basin further comprises a ridged structure at the edges of the fabric basin configured to maintain the open ends shape.
